(19) United States
(12) Patent Application Publication
(10) Pub. No.: US 2006/0230999 A1
(43) Pub. Date: Oct. 19, 2006

(54) Seed preparation and method of using same

(76) Inventor: Mike Long, Kakabeka Falls (CA)

Correspondence Address: Elias C. Borges, Suite 406, 555 Burnhamthorpe Road, Toronto, ON, M9C 2Y3, CA

(21) Appl. No.: 11/104,455

(22) Filed: Apr. 13, 2005

(51) Int. Cl. A01C 1/06; A01C 21/00; A01C 1/00

(52) U.S. Cl. 111/200

(57) ABSTRACT

The present invention is directed at an improved method of planting trees. The method consists of first providing a plurality of seed capsules, each seed capsule comprising a seed contained in a liquid medium enclosed in a sealed frangible capsule. The seed capsuled are in the hopper portion of a launch mechanism, the launch mechanism having a launcher operatively coupled to the hopper for launching the seed capsules. The seeds are then planted on the ground by individually launching the seed capsules at the ground at a velocity selected to burst the frangible capsule of the seed capsules when the seed capsules hit the ground.

### FIELD OF THE INVENTION

The invention relates generally to methods for seeding using encapsulated seeds.

### BACKGROUND OF THE INVENTION

Planting trees is a necessary step in re-forestation. There are generally two methods of tree planting. The first method consists of spreading a large amount of seeds over an area by areal distribution. Essentially, this method involves flying a worker in an airplane over a target planting area. The worker then manually releases the seeds from the airplane as the airplane passes over the target area. As can be appreciated, this method has the advantage of being able to seed large areas of land in a relatively short period of time. However, this method has several drawbacks. Firstly, a great deal of seed is wasted by this method since much of the seed either lands on poor growing locations or is eaten by animals. Also, the seedlings which are sewn via areal distribution tend to grow too close together. As a result, a few years after a field has been sewn by areal distribution, a crew must enter the field and thin the saplings to the desired tree density. This is a labor intensive step which adds greatly to the cost of areal seeding. Finally, there are the considerable costs associated with maintaining an airplane and air crew.

The alternate method of re-forestation involves the manual planting of tree seedlings. This requires first germinating tree seeds and raising the young saplings to about two years of age in a tree nursery. The saplings are then removed from the nursery and taken to the desired planting location, where they are individually planted by hand. This method has several advantages. Firstly, less seed is wasted in this method since the germination and early establishment occurs in the ideal environment of a nursery. Secondly, the saplings are planted individually by hand; therefore, good growing sites can be selected for each sapling planted. Finally, the saplings are planted to the desired final tree density, so there is not need to thin the saplings at a later date. However, this method has a few significant drawbacks. Firstly, there is a significant cost associated with raising a young sapling from seed in a nursery. Also, manually planting the saplings is a back breaking labor intensive operation. Finally, trees grown from planted seedlings are generally not as strong and healthy as trees grown from seeds planted in the native soil. As a result, there is a need for a quick and cost effective method of tree planting which does not have the drawbacks of either hand planting or areal seeding.

### SUMMARY OF THE INVENTION

In accordance with the present invention, there is provided an improved method of planting trees which overcomes the drawbacks of the prior art. The method consists of first providing a plurality of seed capsules, each seed capsule comprising a seed contained in a liquid medium enclosed in a sealed frangible capsule. The seed capsuled are in the hopper portion of a launch mechanism, the launch mechanism having a launcher operatively coupled to the hopper for launching the seed capsules. The seeds are then planted on the ground by individually launching the seed capsules at the ground at a velocity selected to burst the frangible capsule of the seed capsules when the seed capsules hit the ground.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a front view of a seed capsule made in accordance with the invention.

FIG. 2. is a cross sectional view of the seed capsule shown in FIG. 1.

FIG. 3. is a schematic view of an individual seeding the ground using the method of the present invention.

In the drawings like characters of reference indicate corresponding parts in the different figures.

### DETAILED DESCRIPTION OF THE INVENTION

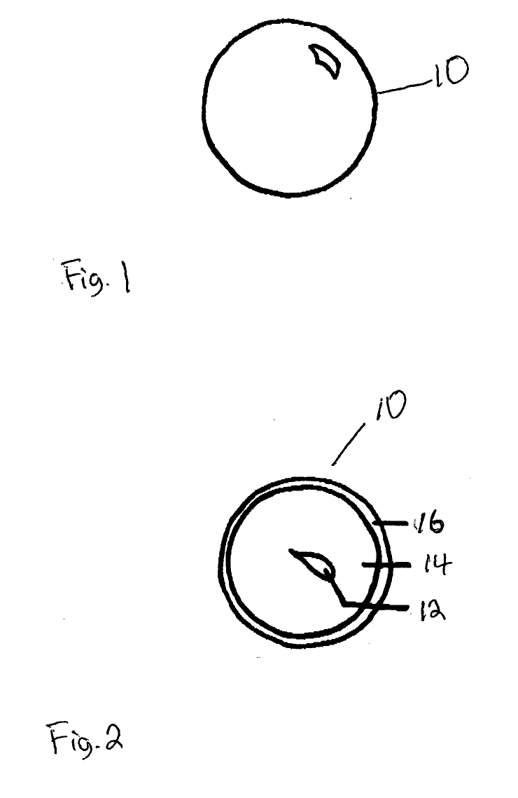

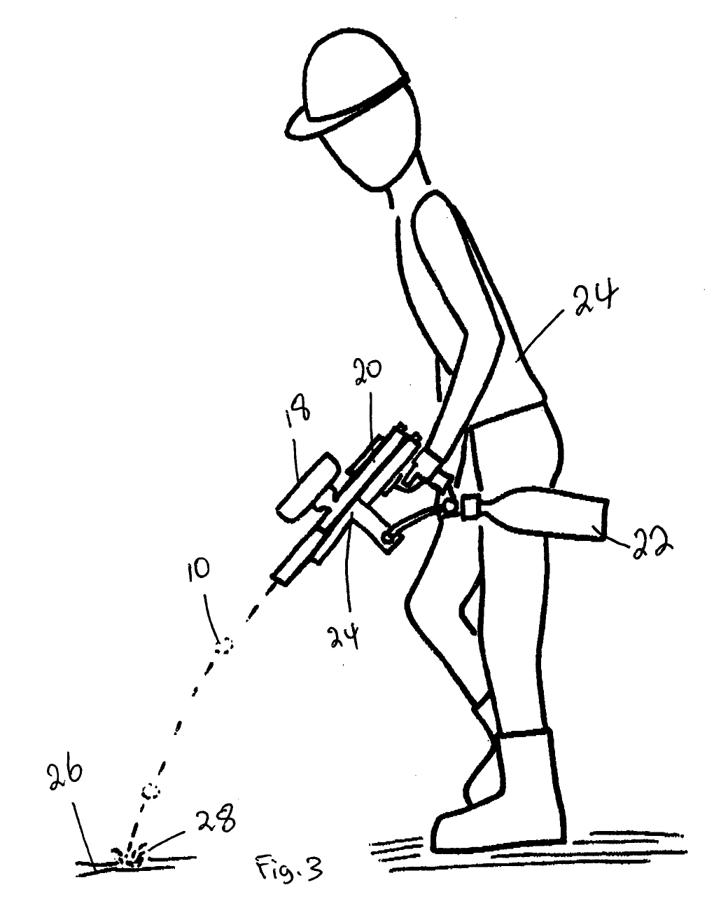

Referring firstly to FIGS. 1 and 2, the method of the present invention involves the hand planting of encapsulated tree seed capsules 10. Seed capsule 10 is similar in structure to paint balls and gelatin bath oil beads currently on the market. Indeed, seed capsules 10 may be manufactured using existing paint ball manufacturing methods and devices which are well known in the art. The seed capsules, shown generally as item 10, each consist of a seed 12 suspended in a liquid medium 14 which is sealed in a soft gel capsule 16. Seed 12 consists of a viable seed of the tree species selected to be planted such as spruce, pine or the like. Soft gel capsule 16 consists of a spherical capsule made of a thickened biodegradable gelatin as used in the manufacture of soft gel paint balls and soft gel bath beads. Capsule 16 will have a diameter of approximately 0.68 inches. The thickness of the gelatin forming capsule 16 and the formulation of gelatin used in constructing the capsule is selected to permit the capsule to split open when the capsule hits the ground (not shown) at a seed of approximately 200 feet per second. Soft gel capsule formulations suitable for use in the present invention are readily available in the marketplace for use in the manufacture of paint balls.

Medium 14 consists of a biodegradable, water soluble liquid medium the ingredients of which are selected to promote the germination and growth of seed 12 upon exposure to air and water. The medium may include a variety of additives to enhance the germination, survival and viability of the germinated seed. For example, the medium may contain anti-fungal agents for inhibiting the growth of fungus on the seed, a germinating agent for encouraging seed germination upon planting, an insect or animal repellent for inhibiting insects and or animals from eating the seed and a fertilizer for nourishing the germinated seed. A great variety of growth enhancing additives are currently available in the marketplace, for example Laponite RD, Laponite RDS, and agar. Of course, the exact composition of the growth enhancing additives will vary depending on the species of seed used and the likely environmental and soil conditions into which the seed is to be planted.

The medium should also include a highly colorful dye for brightly coloring the medium. A brightly colored medium will make it easy to detect the breakage of the seed capsule and the subsequent leakage of the medium.

Referring now to FIG. 3, the method of planting the seed capsules will now be discussed. A quantity of seed capsules 10 are placed in hopper 18 of seed capsule launching device 20. Seed capsule launching device 20 includes a launcher 24 operatively coupled to hopper 18. Launcher 24 is adapted and configured to individually launch seed capsules 10 at ground 26 at a speed sufficient to break open capsule 10 to release the capsules contents. Launcher 20 can be an ordinary paint ball gun (also referred to as a paint ball marker). A variety of suitable paint ball guns are currently available on the market. Currently available paint ball guns use a pneumatic cylinder 22 to power launcher 24 and fire 0.68 caliber paintballs at speeds of between 200 feet per second to 300 feet per second. To commence planting seeds using the method of the present invention, worker 24 first loads a plurality of seed capsules 10 into hopper 18. Most paint ball guns currently on the market today have hoppers which can accommodate approximately 200.68 caliber paint balls or approximately 200 seed capsules. Worker 24 then carries launching device 20 into a field to be planted and locates a good area on ground 26 for planting a seed. The worker aims launching device 20 at ground 26 and launches a seed capsule 10. When seed capsule 10 hits ground 26, it splits open releasing its contents. Since the seed capsules contents includes both the seed and the brightly colored medium, a colored patch 28 will be left on the ground, indicating the location of a planted seed. If the launching failed to produce a colored patch, then the worker knows that the seed capsule failed to rupture upon hitting the ground and can either launch another seed capsule, or ruptured the all ready fired capsule by hand.

The present method has numerous advantages over the prior art. Firstly, a worker can quickly plant literally hundreds of seeds in a very short period of time without the need for bending down. Indeed, it is quite possible for the worker to carry 1000 or more seed capsules on his or her person due to the relatively light weight and compact size of each seed capsule. Also, the worker can quickly judge whether or not an area has been previously seeded by another worker by noting the presence of colored patches in the desired planting area. Also, the seed capsules act as a convenient way of storing a quantity of seeds for a long duration. Finally, the presence of growth promoting additives in the seed capsule medium increases the likelihood that the planted seeds will germinate and grow.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A method of planting seeds on the ground comprising the steps of:
a) providing a plurality of seed capsules, each seed capsule comprising a seed contained in a liquid biodegradable medium enclosed in a sealed frangible capsule,
b) placing the seed capsules in a launch mechanism, the launch mechanism having a hopper for storing the seed capsules and a launcher operatively coupled to the hopper for launching the seed capsules, and
c) individually launching the seed capsules at the ground at a velocity selected to burst the frangible capsule of the seed capsules when the seed capsules hit the ground.

2. The method of claim 1 wherein each seed capsule comprises a spherical soft gelatin capsule filled with the medium, the seed being suspended in the medium.

3. The method of claim 2 wherein the medium is brightly colored by a dye.

4. The method of claim 1 wherein the launch mechanism comprises a hand held paint ball gun.

5. The method of claim of claim 4 wherein each seed capsule comprises a spherical soft gelatin capsule filled with the medium the seed being suspended in the medium and wherein the medium is brightly colored by a dye.

6. The method of claim 1 wherein the launcher comprises a pneumatic launcher.

7. The method of claim 1 wherein the medium contains a germinating agent in sufficient concentration to hasten seed germination when the seed capsule is broken on the ground.

8. The method of claim 1 wherein the medium contains an animal inhibitor in sufficient concentration to inhibit animals from eating the seed contained in the medium after the seed capsule has been broken on the ground.

9. A seed capsule for use with the method of claim 1 comprising a seed suspended in a liquid biodegradable medium, the medium being contained in a sealed soft gelatin capsule, the gelatin capsule being configured to break when the capsule hits the ground at a speed of approximately 200 feet per second.

10. The seed capsule of claim 9 wherein the capsule has a diameter of approximately 0.68 inches.

11. The seed capsule of claim 9 wherein the medium is brightly colored by a dye.

12. The seed capsule of claim 11 wherein the medium also contains a germinating agent in sufficient concentration to hasten seed germination after the seed capsule has been broken on the ground.

13. The seed capsule of claim 12 wherein the medium also contains an animal inhibitor in sufficient concentration to inhibit animals from eating the seed contained in the medium after the seed capsule has been broken on the ground.

14. A method of planting trees on the ground comprising the steps of:
a) providing a plurality of seed capsules, each seed capsule comprising a tree seed contained in a liquid biodegradable medium enclosed in a spherical soft gelatine capsule,
b) placing the seed capsules in a hopper portion of a hand operated paint gun, the paint gun being configured to individually launch the seed capsules towards the ground at a speed sufficient to break the seed capsules when the seed capsules hit the ground, and
c) planting the seeds on the ground by individually launching the seed capsules from the paint gun at the ground.

15. The method of claim 14 wherein the medium is brightly colored by a dye.

16. The method of claim 15 wherein the medium also contains a germinating agent in sufficient concentration to hasten seed germination after the seed capsule has been broken on the ground.

17. The method of claim 16 wherein the medium also contains an animal inhibitor in sufficient concentration to inhibit animals from eating the seed contained in the medium after the seed capsule has been broken on the ground.

18. The method of claim 17 wherein the seed capsule has a diameter of approximately 0.68 inches.

19. The method of claim 14 wherein the paint gun launches the seed capsules at a speed of at least approximately 200 feet per second.

20. The method of claim 19 wherein the paint gun is a pneumatic paint gun.
